(19) United States
(12) Patent Application Publication
(10) Pub. No.: US 2015/0262084 A1
(43) Pub. Date: Sep. 17, 2015

(54) METHODS FOR DEFENDING STATIC AND DYNAMIC REVERSE ENGINEERING OF SOFTWARE LICENSE CONTROL AND DEVICES THEREOF

(71) Applicant: INFOSYS LIMITED, Bangalore (IN)

(72) Inventors: Ashutosh Saxena, Hyderabad (IN); Ravi Sankar Veerubhotla, Hyderabad (IN); Harigopal K.B. Ponnapalli, Hyderabad (IN)

(21) Appl. No.: 14/635,859

(22) Filed: Mar. 2, 2015

(30) Foreign Application Priority Data
Mar. 13, 2014 (IN) 1332/CHE/2014

(51) Int. Cl. G06Q 10/00

(52) U.S. Cl. CPC G06Q 10/00; G06Q 2220/18

(57) ABSTRACT

The technique relates to a method for defending static and dynamic reverse engineering of software license control and devices thereof. To defend static reverse engineering of software license control the licensed application is wrapped with encryption wrapper, wherein the encryption wrapper encrypts the application with a first password. Then, at the time of executing the application, a password prompt is generated. Upon receiving the first password the application is decrypted. At the time of closing the application after execution, another password prompt is generated to create the second password and then the application is re-encrypted with the second password. To defend dynamic reverse engineering of software license control one or more licensing conditions of the licensed application is tested based on control file information, a random number generation or verification point rules. If any license condition violation is detected during testing then the application gets auto-locked by applying self-encryption technique.

### RELATED APPLICATION DATA

This application claims priority to India Patent Application No. 1332/CHE/2014, filed Mar. 13, 2014, the disclosure of which is hereby incorporated by reference in its entirety.

### FIELD OF THE INVENTION

This invention relates generally to software license management, and in particular to a method and device for defending static and dynamic reverse engineering of software license control mechanism.

### BACKGROUND

Software license controls dictate the permissible uses of the corresponding software. The license may include a limitation of time, so that the software is useable only for a period of time. Various control strategies have been employed to make unauthorized duplication and use of software more difficult. One such approach is to provide a hardware dongle which is typically installed in the parallel port of the computer to provide a software interlock. If the dongle is not in place, the software will not execute. The control method is relatively expensive for the developer and cumbersome for the authorized user while remain vulnerable to theft by duplication of the hardware. Another approach to control requires the user to enter a serial number or customer identification number during installation of the software. Missing or invalid registration information prevents installation of the software. This control is easily defeated by transferring the serial number or customer identification number to one or more unauthorized users. Yet another control approach requires registering the software with the manufacturer or distributor to obtain an operational code or password necessary for installation of the software. Once the operational code or password is obtained, it may be perpetually transferred along with pirated copies to numerous unauthorized users.

Perpetual licensing is typically done using one of two types of anti-piracy solutions: 1) hardware-based using a single-user dongle, 2) software-based using client and server technology. Typically, the more expensive the software, the more likely the software publisher is to use a hardware-based solution. This is due to the higher level of security offered, as it relies on an external vendor controlled device, rather than the PC. A software-based protection solution relies on the end user's PC to secure the digital license and maintain adherence to it. Typically, software-based solutions for perpetual licensing enforcement are less expensive than hardware-based, and rely on a technology defined as Product Activation. Product Activation refers to a method in which the customer types in a software Product Key or activation code purchased from the publisher to unlock the product for use, based on the terms of the digital license. Once the activation code is entered by the customer, it is sent over the Internet or by phone call and verified with a server containing all valid codes shipped with the software. After the key is validated by the server, the application is unlocked and gives the customer access to the product. Because the customer has to enter data to activate, most software-based protection solutions require end-user interfaces. Some solutions provide the vendors with an added value of collecting valuable marketing user data through the activation process by integrating User Registration mechanism. However, the single-user dongle does not require the customer to connect to the Internet for verification because the dongle already holds the digital license purchased by the customer. As long as the dongle is plugged into the computer, the software is unlocked and gives the end-user rights to use the software. The license is portable and can be transferred from one PC to another, but only one occurrence of the software application can be run at any one time with one single-user dongle. For perpetual licensing, the digital license stored on the PC or on the dongle will grant the customer the right to use the software forever after purchase.

The major drawbacks of enforcing control of license via dongle is that the solution is very expensive and the solution relies on PC clock for execution, while the PC clock is more prone of hacking allowing users to extend their subscription period without paying. On the other hand the software-based control solution for licensing requires an online license validating server for checking license validity for the software executing at the client workstation.

### SUMMARY

The present disclosure overcomes the above mentioned drawbacks by using completely software based control and thereby removing dependency of the dedicated dongle. The present technique utilizes PC clock for license checking and uses a crypto method to overcome the hacking problem. This technique does not require an online license validating server for checking license validity for the software executing at the client workstation.

According to the present embodiment, a method for defending static and dynamic reverse engineering of software license control is disclosed. The method for defending static reverse engineering of software license control includes wrapping a licensed application with an encryption wrapper, wherein the encryption wrapper encrypts the application with a first password. Thereafter, a password prompt is generated to enter the first password. Upon receiving the first password the licensed application is decrypted and executed in the system/device memory. After executing the licensed application and at the time of closing, a password prompt is generated to create a second password. Then, the licensed application is re-encrypted with the second password. The method for defending dynamic reverse engineering of software license control includes testing one or more licensing conditions of the licensed application based on control file information, a random number generation or verification point rules. The technique determines if at least one of the one or more licensing conditions is violated and if at least one of the one or more licensing conditions is violated more than a predefined threshold, then the licensed application is auto-locked.

In an additional embodiment a software license control device for defending static and dynamic reverse engineering of software license control is disclosed. The software license control device for defending static reverse engineering of software license control includes a memory coupled to one or more processors which are configured to execute programmed instructions stored in the memory including wrapping a licensed application with an encryption wrapper, wherein the encryption wrapper encrypts the application with a first password, generating a password prompt to enter the first password, decrypting the licensed application in memory upon receiving the first password, generating a password prompt to create a second password at the time of closing the licensed application and re-encrypting the licensed application with the second password. The software license control device for defending dynamic reverse engineering of software license control includes a memory coupled to one or more processors which are configured to execute programmed instructions stored in the memory including testing one or more licensing conditions of the licensed application based on control file information, a random number generation or verification point rules, determining if at least one of the one or more licensing conditions is violated and auto-locking the licensed application if the at least one of the one or more licensing conditions is violated more than a predefined threshold time.

In another embodiment, a computer readable storage medium for defending static and dynamic reverse engineering of software license control is disclosed. The computer readable storage medium for defending static reverse engineering of software license control which is not a signal stores computer executable instructions for wrapping a licensed application with an encryption wrapper, wherein the encryption wrapper encrypts the application with a first password, generating a password prompt to enter the first password, decrypting the licensed application upon receiving the first password, generating a password prompt to create a second password at the time of closing the licensed application and re-encrypting the licensed application with the second password. The computer readable storage medium for defending dynamic reverse engineering of software license control which is not a signal stores computer executable instructions for testing one or more licensing conditions of the licensed application based on control file information, a random number generation or verification point rules, determining if at least one of the one or more licensing conditions is violated and auto-locking the licensed application if the at least one of the one or more licensing conditions is violated more than a predefined threshold time.

### BRIEF DESCRIPTION OF THE DRAWINGS

Various embodiments of the invention will, hereinafter, be described in conjunction with the appended drawings. There is no intention to limit the scope of the invention to such blocks or objects, or to any particular technology. These simplified diagrams are presented by way of illustration to aid in the understanding of the logical functionality of one or more aspects of the instant disclosure and is not presented by way of limitation.

FIG. 1 illustrates a generic license management system in accordance with an embodiment of the present disclosure.

FIG. 2 illustrates a software license control device for defending static reverse engineering of software license control, in accordance with an embodiment of the present disclosure.

FIG. 3 illustrates a software license control device for defending dynamic reverse engineering of software license control, in accordance with an embodiment of the present disclosure.

FIG. 4 is a flowchart, illustrating a method for defending static reverse engineering of software license control, in accordance with an embodiment of the present disclosure.

FIG. 5 is a flowchart, illustrating a method for defending dynamic reverse engineering of software license control, in accordance with an embodiment of the present disclosure.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present invention provide a method for defending static and dynamic reverse engineering of software license control and devices thereof. To defend static reverse engineering of software license control the licensed application is wrapped with encryption wrapper, wherein the encryption wrapper encrypts the application with a first password. Then, at the time of executing the application, a password prompt is generated. Upon receiving the first password the application is decrypted. At the time of closing the application after execution, another password prompt is generated to create the second password and then the application is re-encrypted with the second password. To defend dynamic reverse engineering of software license control one or more licensing conditions of the licensed application is tested based on control file information, a random number generation or verification point rules. If any license condition violation is detected during testing then the application gets auto-locked by applying self-encryption technique.

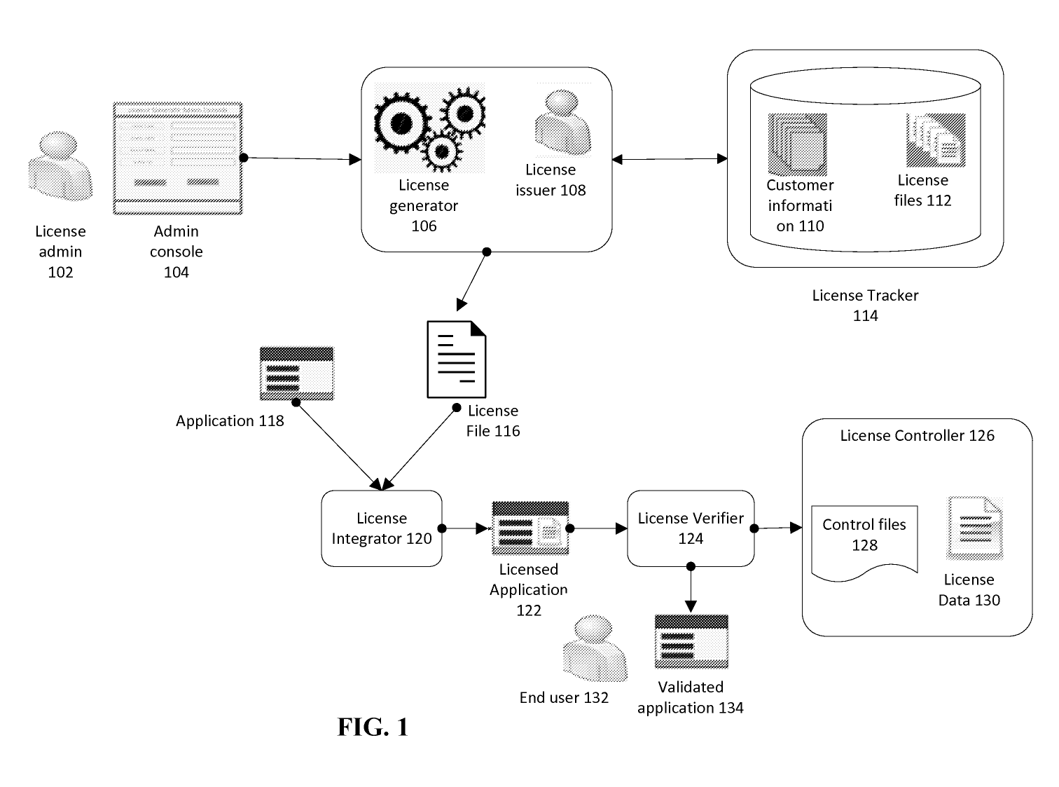

FIG. 1 illustrates a generic license management system in accordance with an embodiment of the present disclosure. The license management system handles the licensing requirements of any software. It typically consists of the mechanisms to generate, validate and manage the licenses. The license management system includes license generator 106, license integrator 120, license controller 126, license verifier 124, license tracker 114, license admin 102, license issuer 108, end user 132 and admin console 104. The license generator 106 generates a license file. The data fields generally include Software Name, Version, vendor name, organization or licensee information, vendor URL, validity period, MAC ID & number of trails. The license integrator 120 provides the integration of licenses with the original application or software to be protected in order to provide the licensing feature. The user of the software has to provide the license file before start using the software. After the license file is validated by the license verifier, the user is given access to the software. The license controller 126 includes control files 128 and license data 130. Whenever the end user accesses the licensed software, the information related to current usage (like the Last Access Date and counter value) is stored in control files 128. The control files provide cryptographic protection for the license. The license verifier 124 is used for runtime validation of Licenses. When the consumer wants to execute the software it needs the credentials to unlock the application. Based on the credential and the current time and previous execution of the software the license controller generates and distributes the licensing conditions in the software which is verified dynamically, whenever they are encountered during the execution. The license tracker 114 is used to track the licenses generated. Moreover it also maintains the records to whom the license was generated and the validity period. The generated licenses are stored in a database which will act as a source for analyzing the consumer behavior such as buying patterns. In short this module maintains history of licenses and profiles of consumers. The license admin 102 customizes the license generator 106 based on the specifications of the software vendor by including the fields of choice. The license admin 102 is also responsible for managing cryptographic protection requirements such as certificates. The license issuer 108 is responsible of generating the licenses based on the license data fields. These fields may include Licensor Name, version, IP address/MAC address of target machine, validity period and so on. License issuer is responsible for the customized issuance of licenses as per the requirements of License Admin. The admin console 104 is a user interface for License admin to generate and manage the licenses. Report Generation is the capability to generate reports on license usage. It also includes generation of Alerts on license expiry/renewal. The end user 132 is the end entity or consumer who is using the licensed software.

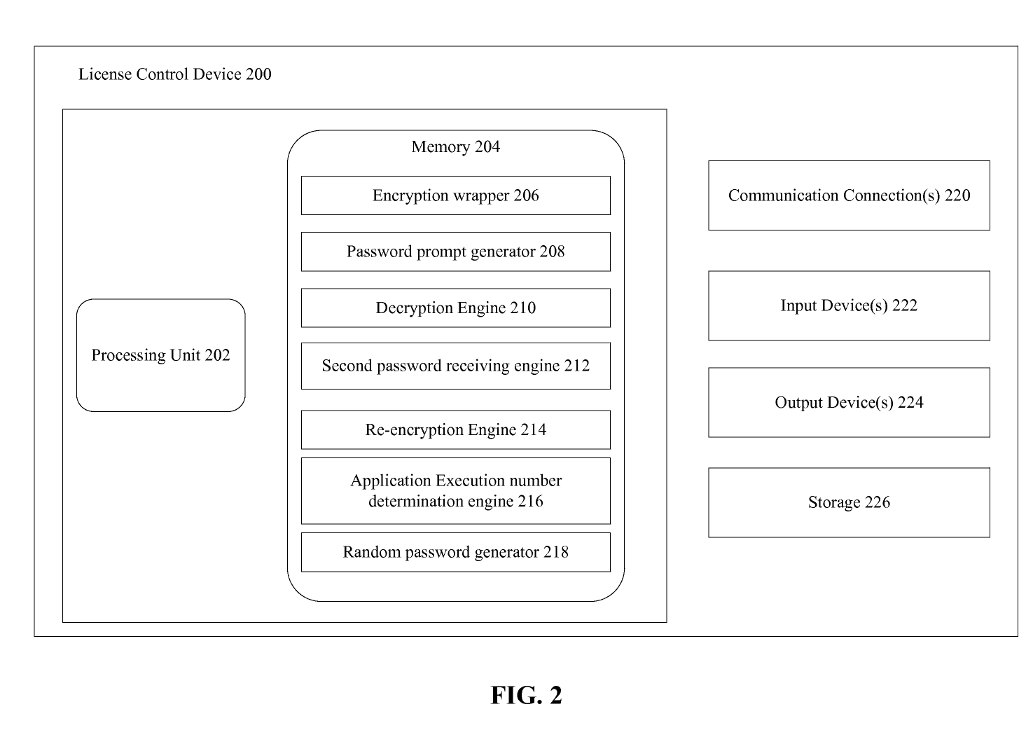

FIG. 2 illustrates a software license control device 200 for defending static reverse engineering of software license control, in accordance with an embodiment of the present disclosure. The software license control device 200 includes a central processing unit (CPU) or processor 202, a memory 204. The processor 202 executes a program of stored instructions for one or more aspects of the present technology as described and illustrated by way of the examples herein, although other types and numbers of processing devices and logic could be used and the processor could execute other numbers and types of programmed instructions. The memory 204 stores these programmed instructions for one or more aspects of the present technology as described and illustrated by way of the examples herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 202, can be used for the memory 204. The memory 204 also includes encryption wrapper 206, password prompt generator 208, decryption engine 210, second password receiving engine 212, re-encryption engine 214, application execution number determination engine 216 and random password generator 218. The encryption wrapper 206 wraps the licensed application. The encryption wrapper 206 encrypts the application with a first password. The password prompt generator 208 generates a password prompt to enter the first password. The decryption engine 210 decrypts the licensed application upon receiving the first password. The second password receiving engine 212 generates a password prompt to create a second password at the time of closing the licensed application. The re-encryption engine 214 re-encrypts the licensed application with the second password. The application execution number determination engine 216 determines if number of execution of the licensed application exceeds an execution number specified in a license control file. The random password generator 218 encrypts the application with a random password if the number of execution of the application exceeds an execution number specified in a license file. The software license control device 200 may have additional features. For example, the device 200 includes storage 226, one or more input devices 222, one or more output devices 224, and one or more communication connections 220. An interconnection mechanism (not shown) such as a bus, a controller, or a network, interconnects the components of the device 200.

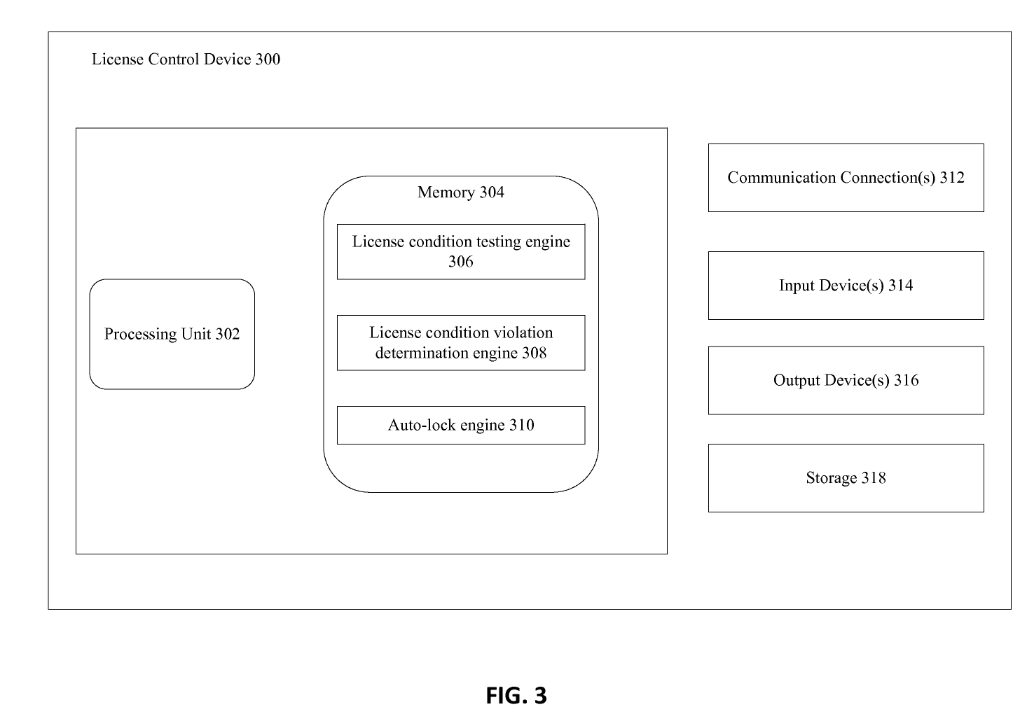

FIG. 3 illustrates a software license control device 300 for defending dynamic reverse engineering of software license control, in accordance with an embodiment of the present disclosure. The software license control device 300 includes a central processing unit (CPU) or processor 302, a memory 304. The processor 302 executes a program of stored instructions for one or more aspects of the present technology as described and illustrated by way of the examples herein, although other types and numbers of processing devices and logic could be used and the processor could execute other numbers and types of programmed instructions. The memory 304 stores these programmed instructions for one or more aspects of the present technology as described and illustrated by way of the examples herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 302, can be used for the memory 304. The memory 204 also includes license condition testing engine 306, license condition violation determination engine 308 and auto-lock engine 310. The license condition testing engine 306 tests one or more licensing conditions of the licensed application based on control file information, a random number generation or verification point rules. Details of testing step is described herein below. The license condition violation determination engine 308 determines if at least one of the one or more licensing conditions is violated. The auto-lock engine 310 locks the licensed application if the at least one of the one or more licensing conditions is violated more than a predefined threshold time. The software license control device 200 may have additional features. For example, the device 300 includes storage 318, one or more input devices 314, one or more output devices 316, and one or more communication connections 312. An interconnection mechanism (not shown) such as a bus, a controller, or a network, interconnects the components of the device 300.

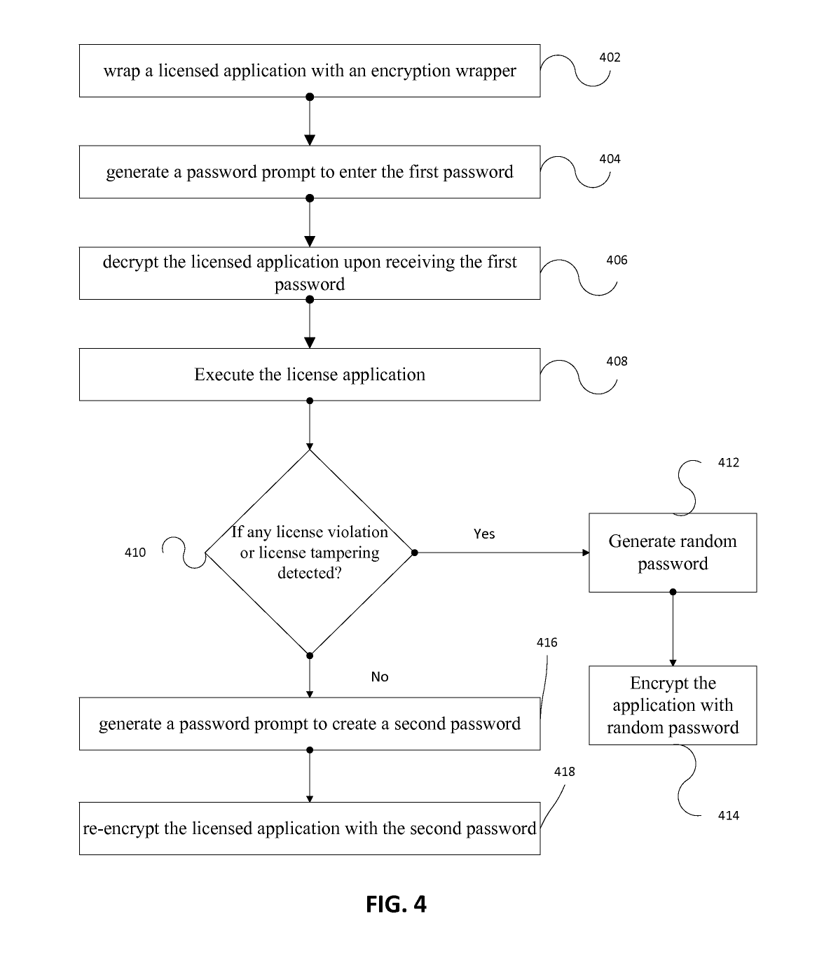

FIG. 4 is a flowchart, illustrating a method for defending static reverse engineering of software license control, in accordance with an embodiment of the present disclosure. The license integrator 120 wraps the licensed application using encryption wrapper 206 at step 402. The encryption wrapper 206 encrypts the application with a first password and outputs the wrapped application. The first password is shared with the end user 132. When the end user 132 tries to execute the wrapped application it generates a password prompt before decrypting and rendering the licensed application at step 404. Upon receiving the first password from the end user 132 the application is decrypted and gets executed at step 406 and 408 respectively. The number of successful executions is maintained in a secure control file and with help of this it detects if any license violation or license tampering happened at step 410. If the end user 132 exceeds the number of executions specified in the license or the tampering of license file (or control file) is detected, the encryption wrapper 206 encrypts the application with random password at step 412 and locks the application at step 414. If the end user 132 does not exceed the number of executions specified in the license or no tampering of license files is detected, then at the time of closing the application the encryption wrapper 206 takes control and prompts to create a second password at step 416. Then the licensed application is re-encrypted with the second password and a new wrapped application is created at step 418. The application is re-encrypted with the new password and a new wrapped application is created after each successful execution, i.e. at the time of second execution of the application it prompts to enter the second password and then decrypt the application upon receiving the second application and then at the time of closing the application after successful execution it'll again prompts to create a third password and encrypts the application with third password and the process will continue until the end user 132 exceeds the number of executions specified in the license or the tampers of license files. This enforces that the application is executed by same individual or the person who knows the new password next time and also enforces limited usage or limited runs of the application.

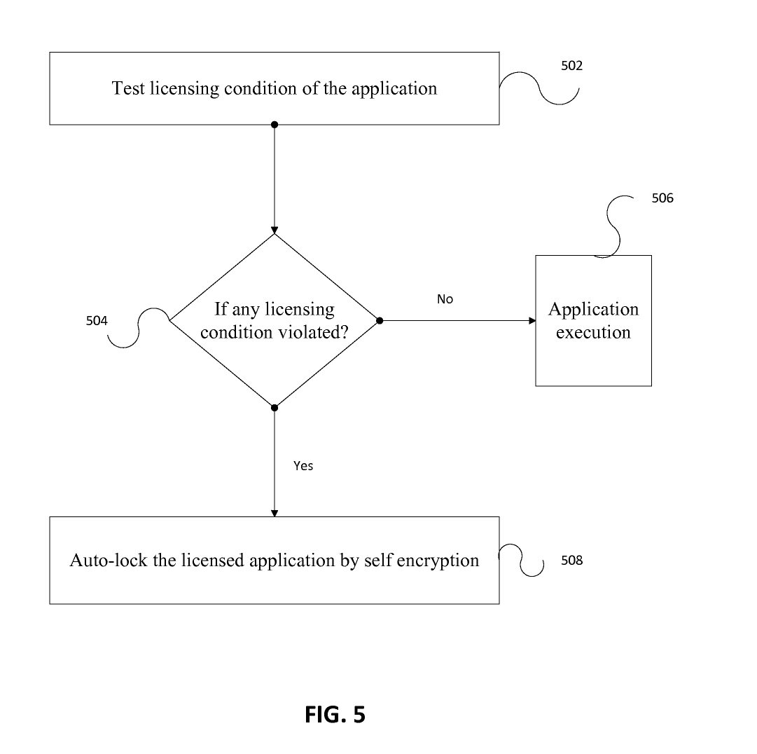

In some instances the end user 132 reverse engineers the licensed application and bypass the licensing checks to get an extended validity of license. Dynamic validation of licenses checks licensing conditions at different intervals and supports robust verification process for licenses. Using this, software binaries can be customized for end users with different licensing conditions or license conditions at multiple places. FIG. 5 is a flowchart, illustrating a method for defending dynamic reverse engineering of software license control, in accordance with an embodiment of the present disclosure. The licensing conditions are tested dynamically based on control file information, a random number generation or verification point rules at step 502. It determines if any licensing conditions are violated at step 504. If it detects any violation of licensing conditions then it auto-locks the application at step 508 using self-encryption technique mentioned at step 412 and 414 of FIG. 4. According to an embodiment of the present disclosure the license verifier 124 reads the control files 128 which holds the line number(s) or similar information on where to perform the license checks. These control files 128 are unique to each customer and created at the time of License integration or license generation for the end user 132. License verifier 124 checks the license conditions as per the control file(s) 128 and in case of failure it is logged in a file and the application exits immediately. If the number of failure attempts exceeds certain threshold, the self-encryption technique is called and the application locks itself as mentioned in step 508. According to another embodiment of the present disclosure, the license verifier 124 generates a random number which in turn identifies the line numbers on where to perform license checks. This method replaces the need of maintaining control files 128. License verifier 124 checks the license conditions and in case of failure it is logged in a file and the application exits immediately. In yet another embodiment of the present disclosure, the license verifier 124 uses rules or attributes to identify license verification points. These verification points (part of the rules) are created at the time the application is licensed to the end user 132. These license verification points can be in different modules of the application, and they can be created if certain conditions on the application usage are met or can be based on certain selected attributes of the licensee's profile. These rules are maintained in a secure storage either in file format or in a database. License verifier checks the license conditions based on these rules. In case of failure of license verification it is logged in a file and the application exits immediately.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer-implemented method executed by one or more computing devices for defending static reverse engineering of software license control, the method comprising:
wrapping, by at least one of the one or more computing devices, a licensed application with an encryption wrapper, wherein the encryption wrapper encrypts the licensed application with a first password;
generating, by at least one of the one or more computing devices, a password prompt to enter the first password;
decrypting, by at least one of the one or more computing devices, the licensed application upon receiving the first password;
generating, by at least one of the one or more computing devices, a password prompt to create a second password at the time of closing the licensed application; and
re-encrypting, by at least one of the one or more computing devices, the licensed application with the second password.

2. The method of claim 1, further comprising:
determining if number of execution of the licensed application exceeds an execution number specified in a license control file; and
encrypting the licensed application with a random password if the number of execution of the licensed application exceeds an execution number specified in a license file.

3. The method of claim 1, wherein the re-encrypting of the licensed application is performed after the license application is executed.

4. The method of claim 1, wherein the re-encrypted licensed application is decrypted with the second password.

5. The method of claim 1, wherein the licensed application is encrypted with a new password after each successful execution of the licensed application.

6. A computer-implemented method executed by one or more computing devices for defending dynamic reverse engineering of software license control, the method comprising:
testing, by at least one of the one or more computing devices, one or more licensing conditions of a licensed application based on control file information, a random number generation or verification point rules;
determining, by at least one of the one or more computing devices, if at least one of the one or more licensing conditions is violated; and
auto-locking, by at least one of the one or more computing devices, the licensed application if the at least one of the one or more licensing conditions is violated more than a predefined threshold time.

7. The method of claim 6, wherein the testing is performed during execution of the licensed application.

8. The method of claim 6, wherein the control file information includes information related to line numbers on where the license check is required to be performed.

9. The method of claim 6, wherein the random number identifies line numbers on where the license check is required to be performed.

10. The method of claim 6, wherein the verification point rules identify one or more license verification points.

11. A software license control device comprising:
one or more processors; and
one or more memories operatively coupled to at least one of the one or more processors and having instructions stored thereon that, when executed by at least one of the one or more processors, cause at least one of the one or more processors to:
wrap a licensed application with an encryption wrapper, wherein the encryption wrapper encrypts the licensed application with a first password;
generate a password prompt to enter the first password;
decrypt the licensed application upon receiving the first password;
generate a password prompt to create a second password at the time of closing the licensed application; and
re-encrypt the licensed application with the second password.

12. The software license control device of claim 11, wherein at least one of the one or more memories has further instructions stored thereon that, when executed by at least one of the one or more processors, cause at least one of the one or more processors to:
determine if number of execution of the licensed application exceeds an execution number specified in a license control file; and
encrypt the licensed application with a random password if the number of execution of the licensed application exceeds an execution number specified in a license file.

13. The software license control device of claim 11, wherein the licensed application is re-encrypted after execution.

14. The software license control device of claim 11, wherein the re-encrypted licensed application is decrypted with the second password.

15. The software license control device of claim 11, wherein the licensed application is encrypted with a new password after each successful execution of the licensed application.

16. A software license control device comprising:
one or more processors; and
one or more memories operatively coupled to at least one of the one or more processors and having instructions stored thereon that, when executed by at least one of the one or more processors, cause at least one of the one or more processors to:
test one or more licensing conditions of a licensed application based on control file information, a random number generation or verification point rules;
determine if at least one of the one or more licensing conditions is violated; and
auto-lock the licensed application if the at least one of the one or more licensing conditions is violated more than a predefined threshold time.

17. The software license control device of claim 16, wherein the license application is tested during execution.

18. The software license control device of claim 16, wherein the control file information includes information related to line numbers on where the license check is required to be performed.

19. The software license control device of claim 16, wherein the random number identifies line numbers on where the license check is required to be performed.

20. The software license control device of claim 16, wherein the verification point rules identify one or more license verification points.

21. At least one non-transitory computer-readable medium storing computer-readable instructions that, when executed by one or more computing devices, cause at least one of the one or more computing devices to:
wrap a licensed application with an encryption wrapper, wherein the encryption wrapper encrypts the licensed application with a first password;
generate a password prompt to enter the first password;
decrypt the licensed application upon receiving the first password;
generate a password prompt to create a second password at the time of closing the licensed application; and
re-encrypt the licensed application with the second password.

22. At least one non-transitory computer-readable medium storing computer-readable instructions that, when executed by one or more computing devices, cause at least one of the one or more computing devices:
testing one or more licensing conditions of a licensed application based on control file information, a random number generation, or verification point rules;
determining if at least one of the one or more licensing conditions is violated; and
auto-locking the licensed application if the at least one of the one or more licensing conditions is violated more than a predefined threshold time.
